(19) United States
(12) Patent Application Publication
(10) Pub. No.: US 2012/0155219 A1
(43) Pub. Date: Jun. 21, 2012

(54) System and Method for Acoustic Recording in Well Bottomhole Assembly while Firing A Perforating Gun

(76) Inventors: Laurent Alteirac, Borgen (NO); Robert J. Ingham, Paris (FR); James G. Filas, Missouri City, TX (US)

(21) Appl. No.: 13/315,327

(22) Filed: Dec. 9, 2011

(30) Foreign Application Priority Data
Dec. 10, 2010 (US) PCT/US10/59791

(51) Int. Cl. G01V 1/40

(52) U.S. Cl. 367/81

(57) ABSTRACT

A sensing and data recording downhole system and method for monitoring of firing of a perforating gun system in a well, including a perforating gun system having charges or bullets for performing well perforation; and one or more downhole recorders and/or one or more fluid detection sensors located above, along, below or in array on the perforating gun system or inside the perforating gun system on a conveyance and configured to at least one of record sound waves generated by explosions of the charges or bullets during the firing of the perforating gun system and detect a presence of fluid within a body of the perforating gun system before and after guns of the perforating gun system are fired.

### TECHNICAL FIELD

The present disclosure generally relates to systems and methods for well testing, and more particularly, but not by way of limitation, to a system and method employing acoustic and leak detection data recording downhole while firing perforating guns during well testing or completion operations.

### BACKGROUND ART

Once a casing for a well used to produce hydrocarbons has been set and cemented across a hydrocarbon reservoir, the casing needs to have holes punched in it and in the surrounding cement sheath to allow the hydrocarbons to enter the well bore. A perforating gun is a device that can be used to perforate the casing and the cement sheath. The perforating gun can be run on a wireline, often with gamma ray/casing-collar locator assembly. Alternatively, perforating guns can be conveyed on tubing or pipe employing tubing-conveyed perforating (TCP) techniques. Perforating guns include either a set of guns spaced apart, e.g., by about six inches, which fire bullets, or a string of shaped charges that are delivered downhole to a desired depth and are fired to perforate the casing or liner. A typical perforating gun can carry many dozens of guns or charges. However, there is a need to determine if all of the bullets or charges have fired, and other parameters relating to the charge detonation.

### SUMMARY OF THE DISCLOSURE

The above and other needs and problems are addressed by the exemplary embodiments of the present disclosure, which provide a novel system and method employing fluid detection sensors and/or acoustic data recording downhole while firing perforating gun systems during well testing. In an exemplary embodiment, an exemplary system can include one or more downhole sensors with or without an associated recorder that is provided on a conveyance, such as a drill stem testing string, a wireline, E-line, slickline or coiled tubing or any other desired conveyance. If E-line is used, it enables the use of electrical signals from the surface to fire the gun system having guns or charges. However, a slickline, which is lowered into a well casing, does not provide for communication with the surface. Rather, a mechanism on the gun system arms the guns or charges when a certain temperature and pressure is reached, or a specific slickline tension or wellbore pressure signature is recognized, and a timer then fires the guns or charges, following a set time interval. The sensors can be located above, along, below, in an array on a perforating gun system, or inside a gun system which includes guns or charges. The sensors can include an acoustic sensor for recording sound waves or a fluid detection sensor for detecting the presence of a fluid within a space within the gun that initially contained a gas, such as air. The sound waves from the acoustic sensor and leak data from the fluid detection sensor generated by the firing of bullets or explosions of the charges of the perforating gun system are recorded by the recorders for analysis, including determining if all of the guns or charges have fired, and other parameters relating to the gun firing or charge detonation.

Accordingly, in an exemplary aspect of the present disclosure there is provided a sensing and data recording downhole system and method for monitoring of firing of a perforating gun system in a well, including a perforating gun system having charges or bullets for performing well perforation; and at least one of one or more downhole recorders and one or more fluid detection sensors located above, along, below or in array on the perforating gun system or inside the perforating gun system on a conveyance and configured to either (1) record sound waves generated by explosions of the charges or bullets during the firing of the perforating gun system or (2) detect a presence of fluid within a body of the perforating gun system before and after guns of the perforating gun system are fired.

The downhole recorders can include an accelerometer based sensor, or a piezoelectric stack based sensor for measuring acceleration versus time of the sound waves generated by the explosions of the charges or the bullets.

The downhole recorders can be configured to record the sound waves and leak data generated by the explosions of the charges or the bullets during the firing of the perforating gun continuously or in time windows.

The downhole recorders can include a telemetry channel for transmitting the recorded sound waves and leak data generated by the explosions of the charges or the bullets.

The telemetry channel can be one of an acoustic, electromagnetic, wire, and pressure pulse telemetry channel.

The downhole recorders can be configured to upload a sound file of the recorded sound waves and leak data generated by the explosions of the charges or the bullets during the firing of the perforating gun once the downhole recorders are retrieved from downhole.

The system and method can be configured to perform analysis of the sound file and leak data to determine one or more parameters, including percentage of the charges or bullets of the perforating gun system which properly detonated or properly fired, respectively.

The system and method can be configured to perform analysis of the sound file and leak data to determine one or more parameters including a derivative of energy released during detonation of the charges or firing of the bullets.

The system and method can be configured to perform analysis of the sound file and leak data in situ downhole to provide real or near real time telemetry data to the surface based on results of the analysis, and including whether or not the perforating gun system was triggered and a time thereof, and percentage of the charges or bullets of the perforating gun system which properly detonated or properly fired, respectively.

The conveyance can include either a drill stem testing string or completion string.

In a further exemplary aspect of the present disclosure there is provided a sensing and data recording downhole system and method for monitoring the firing of a perforating gun system in a well, including a perforating gun system having a string of multiple perforating guns each having charges or bullets for performing well perforation; one or more downhole fluid detection sensors located within a lowest perforating gun within the string of multiple perforating guns and configured to detect a presence of fluid within an interior of a gun body of the lowest perforating gun; and an associated wireless transceiver and telemetry system capable of relaying sensor data from the downhole fluid detection sensors up the gun string to the surface.

The fluid detection sensors can include an associated recording device for recording sensor data measurements from the fluid detection sensors versus time.

In a further exemplary aspect of the present disclosure there is provided a system and method for confirming that a ballistic train traveling within a perforating gun string has propagated down to a lowest perforating gun of the gun string, including a wireless telemetry system configured to query a fluid detection sensor located within a lowest perforating gun of a perforating gun string; a recorder device configured to record first measurements from the fluid detection sensor; a gun fire control system configured to issue a command to fire the perforating gun string; the wireless telemetry system configured to query the fluid detection sensor located within the lowest perforating gun after the gun fire control system issues the command to fire the perforating gun string; the recorder device configured to record second measurements from the fluid detection sensor; and a computer processor configured to compare the first and second fluid detector sensor measurements to confirm that the lowest perforating gun has flooded with fluid indicating that the lowest perforating gun has detonated.

Still other aspects, features, and advantages of the present invention are readily apparent from the entire description thereof, including the figures, which illustrate a number of exemplary embodiments and implementations. The invention is also capable of other and different embodiments, and its several details can be modified in various respects, all without departing from the spirit and scope of the invention. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIG. 1 illustrates an exemplary system, including a recording tool located above perforating gun on a drill stem testing string;

FIG. 2 illustrates an exemplary recorder of the system of FIG. 1; and

FIG. 3 illustrates an exemplary graph of a time domain representation of a sound file of charge explosions corresponding to the system of FIG. 1.

### DETAILED DESCRIPTION

Various embodiments and aspects of the invention will now be described in detail with reference to the accompanying figures. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited. Further, whenever a composition, a group of elements or any other expression is preceded by the transitional phrase “comprising”, “including” or “containing”, it is understood that it is also contemplated the same composition, the group of elements or any other expression with transitional phrases “consisting essentially of”, “consisting”, or “selected from the group of consisting of”, preceding the recitation of the composition, the elements or any other expression. The term “system” may also be referred to herein as “apparatus”.

The present disclosure includes recognition that one aspect of problems related with perforating guns is to determine that a firing command has been received by the perforating gun and that the upper charges of the perforating gun have detonated. In the case where there are multiple guns deployed, it is also of interest to determine if the ballistic train has successfully propagated down to the lowest gun, causing the lowest gun to fire. Knowing that the last gun has fired is advantageous for confirming that the perforating event was successfully performed before pulling the fired gun string out of the hole, so as to ensure that any undetonated guns will not be pulled to the surface.

The present disclosure further includes recognition that one aspect of problems related with a string of multiple perforating guns is to determine that the corresponding ballistic train has propagated down to the lowest gun of the gun string. Advantageously, such determination provides real-time knowledge that a perforating event was successfully performed before pulling the gun string from downhole, so as to ensure that undetonated guns are not be pulled to the surface. While processing of recorded acoustic waveforms can be used to determine if the guns have initially fired and to further assess how much of the gun string has detonated, such processing may not conclusively and positively determine if the lowest gun of the gun string has detonated. In an exemplary embodiment, in order to determine if the lowest gun of the gun string has detonated, a sensor can be placed at the position of the lowest gun in combination with a wireless communication system to provide last shot detection, immediately after the perforating event has occurred. In the case of a casing gun, in which the charges are enclosed in a sealed body, a sensor, such as a fluid detection sensor, leak sensor, and the like, can be placed inside the body of the lowest gun and include an associated wireless communication transceiver, such as an electro-magnetic or acoustic telemetry system, and the like. Since the interior of the gun body is dry before the gun is fired and becomes flooded with borehole fluids after the charges have detonated and formed exit holes in the body of the perforating gun, the fluid detection sensor will be surrounded by fluid after the gun has successfully detonated. The fluid detection sensor communicates its measurement to the associated wireless communication device, which then broadcasts the measurement results up the gun string to the surface, for example, through a system of wireless telemetry repeaters located along the gun string, thus providing for a wireless last-shot detection system. The fluid detection sensor located within the gun body can be a resistivity-based sensor, a capacitance-based sensor, an optical-based sensor, a pressure-based sensor, any other suitable type of sensor, and the like, capable of detecting a presence of a fluid versus the initial gas (e.g., typically air) that is present in the gun body before detonation occurs.

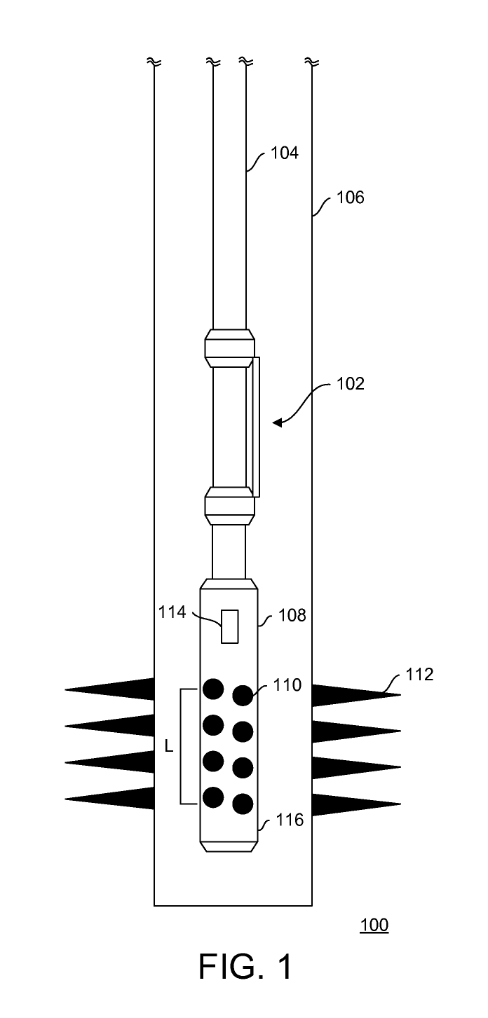

Referring now to the drawings, wherein like reference numerals designate identical or corresponding parts throughout the several views, and more particularly to FIG. 1 thereof, there is illustrated an exemplary system 100, including a perforating gun system (also referred to herein as a “perforating gun”) and one or more recording tools (also referred to herein as a “downhole recorders”) located above, along, below, or in an array on a perforating gun on a drill stem testing string. In FIG. 1, the exemplary system 100 includes one or more downhole recorders 102, which may be provided on a completion string or a drill stem testing string 104, that is lowered into a well casing 106. The recorder 102 can be located above, along, below, or in an array on a perforating gun system 108 having charges 110 or alternatively including the previously described guns (not shown) instead or in addition to the charges 110 (e.g., including Capsule Gun Perforating Systems, Hollow Carrier Gun Perforating Systems, P4 Post-Perforation Propellant Pulse Systems, High Shot Density (HSD) Systems, etc., all available from Schlumberger, and the like). The charges or the bullets, when detonated or fired, respectively, are used to create perforations 112 in the casing 106. Sensors in the recorder 102 can include an accelerometer, a piezoelectric stack, temperature sensors, pressure sensors, leak sensors, fluid detection sensors, and the like.

In an exemplary embodiment, one or more fluid detection sensors 114 can be located within the body 116 of the perforating gun system 108 and electrically coupled to the recorder 102. The information, such as sound waves, leak data, and the like, generated by the explosions of the charges 110 (or the firing of the guns) of the perforating gun system 108 are captured by the sensors and recorded by the recorder 102. The downhole sensor data and sounds can be recorded continuously, in time windows, or by similar means. The resulting sensor data and sound files may be transmitted in real or near real time to the surface using any suitable telemetry channel (e.g., acoustic, electromagnetic, wire, pressure pulse, etc.).

In a further exemplary embodiment, the sensor data and sound file can be uploaded at the surface once the recording tool 102 is retrieved from downhole and while the gun system 108 is downhole. Advantageously, post processing analysis of the sensor data and sound file can be used to determine various parameters of interest, for example, including percentage of the length (L) of the gun string of charges or percentage of guns of the gun system 108 which properly detonated or properly fired, respectively; derivative of the energy released during the charge 110 detonation or guns discharge; and/or any other relevant parameters, and the like.

In a further exemplary embodiment, the analysis of the sensor data and sound file can be performed in situ downhole and the real or near real time telemetry data can be used to provide to the surface the results of the analysis, for example, including:

Gun triggered: Yes/No

Time of trigger: XX:XX:XX

Percentage of the gun string triggered: XX %

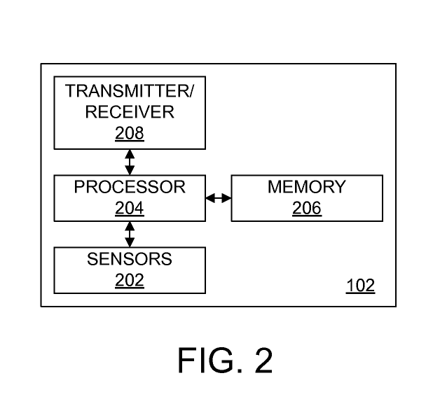

FIG. 2 illustrates the exemplary recorder 102 of the system 100 of FIG. 1. In an exemplary embodiment, the recorder 102 may be configured to include a telemetry channel for receiving start/stop/status request/triggering command/synchronization data. In FIG. 2, the recorder 102 is shown to include one or more sensors 202 and/or the sensors 114 (e.g., accelerometer based sensors, piezoelectric stack based sensors, temperature based sensors, pressure based sensors, leak sensors, fluid detection sensors, etc.) coupled to a processor 204. The processor 204 is coupled to a memory device 206 for storing sensor data, sound files, leak data, parameters, and the like, and to a transmitter/receiver device 208 (e.g., to implement the acoustic, electromagnetic, wire, pressure pulse, etc., based telemetry channel), and as described with respect to the system 100 of FIG. 1.

The fluid detection sensor 114 can be placed within the body 116 of the gun 108 located at the bottom of a string 104 of multiple guns 108 (not shown). The wireless communication transceiver 208 of the recorder 102 forms a wireless telemetry system (e.g., an acoustic or electro-magnetic telemetry system, etc.) capable of transmitting sensor information up the pipe string 104, and which can be attached on or provided within the lower gun 108 body 116, such that the system is in electrical communication with the fluid detection sensor 114. The fluid detection sensor 114 can be queried from the surface, via the wireless telemetry system, before a command to fire the guns 108 is given, after confirming with the sensor 114 that there is no fluid surrounding the sensor 114. After the guns 108 of the gun string 104 have fired, if the detonation train has successfully traveled throughout the entire series of guns 108 to the lowest gun 108 in the string 104, then once the charges 110 in the lowest gun 108 of the string 104 have detonated, the body 116 of the lowest gun 108 is perforated, along with the well casing 106, resulting in borehole fluid entering the gun body 116 of the lowest gun 108. At this time, the fluid detection sensor 114 can once again be queried to confirm that the sensor 114 is now surrounded with fluid and indicating that the lowest gun 108 has fired.

In further exemplary embodiments, multiple fluid detection sensors 114 can be disposed at various locations within the lowest gun 108 body 116, each having an associated recording system 102 to record sensor measurement versus time information, with each sensor 114 and recording system 102 being in communication with a wireless telemetry transceiver 208. An analysis of the time series data from the multiple sensors 114 can be used to confirm that each sensor 114 within the lowest gun 108 was exposed to wellbore fluid at virtually the same instant due to the simultaneous perforation of the gun body 116 at the multiple charge 110 locations along the length of the gun 108, based on a firing command issued from a gun fire control system (not shown) configured for firing the string 104 of perforating guns 108. This information can be used to eliminate the possibility that the lowest gun 108 flooded more slowly, for example, due to a leak due to a mechanical failure of a seal or o-ring, which was caused by the explosive shock from another gun 108 higher in the sting 104, rather than from the successful detonation of the charges 110 in the lowest gun 108. In further exemplary embodiments, one or more respective sensors 114 and recorders 102 can be provided on each of multiple guns 108 of a string 104 of guns 108, advantageously, increasing the accuracy of the overall system.

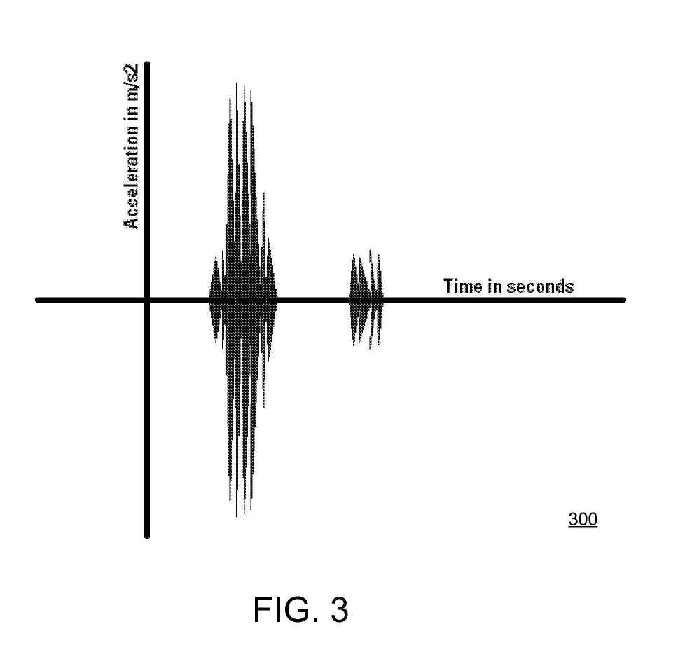

FIG. 3 illustrates an exemplary graph 300 of a time domain representation of a sound file which may be produced by charge explosions of the system 100 of FIG. 1. In FIG. 3, acceleration (e.g., in m/sec²) on the y axis is plotted against time (e.g., in seconds) on the x axis and can be used to perform the above-noted analysis, using any suitable techniques, as will be appreciated by those skilled in the relevant art(s). Similar, graphs can be generated based on the recorded sensor data, such as leak detection over time, and the like.

While the inventions have been described in connection with a number of exemplary embodiments, and implementations, the inventions are not so limited, but rather cover various modifications, and equivalent arrangements, which fall within the scope of the appended claims.

What is claimed is:

1. A sensing and data recording downhole system for monitoring of firing of a perforating gun system in a well, the system comprising:
a perforating gun system having charges or bullets for performing well perforation; and
one or more downhole recorders and/or one or more fluid detection sensors located above, along, below or in array on the perforating gun system or inside the perforating gun system on a conveyance, and configured to at least one of record sound waves generated by explosions of the charges or bullets during the firing of the perforating gun system and detect a presence of fluid within a body of the perforating gun system before and after guns of the perforating gun system are fired.

2. The system of claim 1, wherein the downhole recorders include at least one of an accelerometer based sensor, and a piezoelectric stack based sensor for measuring acceleration versus time of the sound waves generated by the explosions of the charges or the bullets.

3. The system of claim 1, wherein the downhole recorders are configured to record the sound waves and leak data generated by the explosions of the charges or the bullets during the firing of the perforating gun continuously or in time windows.

4. The system of claim 1, wherein the downhole recorders include a telemetry channel for transmitting the recorded sound waves and leak data generated by the explosions of the charges or the bullets.

5. The system of claim 4, wherein the telemetry channel is one of an acoustic, electromagnetic, wire, and pressure pulse telemetry channel.

6. The system of claim 1, wherein the downhole recorders are configured to upload a sound file of the recorded sound waves and leak data generated by the explosions of the charges or the bullets during the firing of the perforating gun once the downhole recorders are retrieved from downhole.

7. The system of claim 6, wherein the system is configured to perform analysis of the sound file and leak data to determine one or more parameters, including percentage of the charges or bullets of the perforating gun system which properly detonated or properly fired, respectively.

8. The system of claim 6, wherein the system is configured to perform analysis of the sound file and leak data to determine one or more parameters including a derivative of energy released during detonation of the charges or firing of the bullets.

9. The system of claim 6, wherein the system is configured to perform analysis of the sound file and leak data in situ downhole to provide real or near real time telemetry data to the surface based on results of the analysis, and including whether or not the perforating gun system was triggered and a time thereof, and percentage of the charges or bullets of the perforating gun system which properly detonated or properly fired, respectively.

10. The system of claim 1, wherein the conveyance comprises either a drill stem testing string or completion string.

11. A method of downhole data recording for monitoring of firing of a perforating gun system in a well, the method comprising:
performing well perforation with a perforating gun system having charges or bullets; and
at least one of recording sound waves generated by explosions of the charges or bullets during the firing of the perforating gun system and detecting a presence of fluid within a body of the perforating gun system before and after guns of the perforating gun system are fired with one or more downhole recorders and/or one or more downhole recorders fluid detection sensors located above, along, below or in array on the perforating gun system or inside the perforating gun system on a conveyance.

12. The method of claim 11, wherein the downhole recorders include at least one of an accelerometer based sensor, and a piezoelectric stack based sensor for measuring acceleration versus time of the sound waves generated by the explosions of the charges or the bullets.

13. The method of claim 11, wherein the downhole recorders are configured to record the sound waves and leak data generated by the explosions of the charges or the bullets during the firing of the perforating gun continuously or in time windows.

14. The method of claim 11, wherein the downhole recorders include a telemetry channel for transmitting the recorded sound waves and leak data generated by the explosions of the charges or the bullets.

15. The method of claim 14, wherein the telemetry channel is one of an acoustic, electromagnetic, wire, and pressure pulse telemetry channel.

16. The method of claim 11, wherein the downhole recorders are configured to upload a sound file of the recorded sound waves and leak data generated by the explosions of the charges or the bullets during the firing of the perforating gun once the downhole recorders are retrieved from downhole.

17. The method of claim 16, wherein the system is configured to perform analysis of the sound file and leak data to determine one or more parameters, including percentage of the charges or bullets of the perforating gun system which properly detonated or properly fired, respectively.

18. The method of claim 16, wherein the system is configured to perform analysis of the sound file and leak data to determine one or more parameters including a derivative of energy released during detonation of the charges or firing of the bullets.

19. The method of claim 16, wherein the system is configured to perform analysis of the sound file and leak data in situ downhole to provide real or near real time telemetry data to the surface based on results of the analysis, and including whether or not the perforating gun system was triggered and a time thereof, and percentage of the charges or bullets of the perforating gun system which properly detonated or properly fired, respectively.

20. The method of claim 11, wherein the conveyance comprises either a drill stem testing string or completion string.

21. A sensing and data recording downhole system for monitoring the firing of a perforating gun system in a well, the system comprising:
a perforating gun system having a string of multiple perforating guns each having charges or bullets for performing well perforation;
one or more downhole fluid detection sensors located within a lowest perforating gun within the string of multiple perforating guns and configured to detect a presence of fluid within an interior of a gun body of the lowest perforating gun; and
an associated wireless transceiver and telemetry system capable of relaying sensor data from the downhole fluid detection sensors up the gun string to the surface.

22. The system of claim 21, wherein the fluid detection sensors include an associated recording device for recording sensor data measurements from the fluid detection sensors versus time.
